(19) United States
(12) Patent Application Publication
(10) Pub. No.: US 2005/0042585 A1
(43) Pub. Date: Feb. 24, 2005

(54) Method and system for providing career guidance information

(76) Inventor: Steven Farrell Eskenazi, Avon, CT (US)

Correspondence Address: WEISS & MOY PC, 4204 NORTH BROWN AVENUE, SCOTTSDALE, AZ, 85251, US

(21) Appl. No.: 10/643,104

(22) Filed: Aug. 18, 2003

(51) Int. Cl. G09B 19/00

(52) U.S. Cl. 434/219

(57) ABSTRACT

A method and system for providing career guidance information provides a tool for both individuals and guidance agencies to present career information in an interactive manner to a computer user. A first user interface is provided having a collection of drop-down lists for selecting a particular career within a job category associated with each list. Upon selection of a particular career within a list, an information screen with a job description is loaded and a menu is provided for selection of further information options including day-in-the-life videos, job statistics, pay information and conversational helpers. The content may be loaded from the Internet, local files or both, and the menu is adapted to provide seamless integration of the Internet and local storage content.

### BACKGROUND OF THE INVENTION

1. Field of the Invention

The present invention relates generally to information systems, and more specifically, to a method and system for delivering career guidance information over a network.

2. Background of the Invention

Present-day network systems including the Internet provide access to a wealth of information. In particular, career information in the form of survey data is available at various government and private sites. However, such information is only partially useful to a person seeking career guidance such as a high school student attempting to plan their course-of-study and potential post-secondary educational needs, or a college student or person seeking an alternative career. The information is not organized for browsing of career options and typically includes little or no information about requirements for a particular career or the day-to-day work life of a person involved in a particular career. As the additional information described above is critical in making career decisions, as well as for academic planning, the additional information needs to be accessible to students and others making career decisions.

Further, guidance counselors and agencies need a tool for providing such information to students and others, in order to serve more persons more efficiently and to include a quantity and organization of information not available through traditional means such as guidance office books and pamphlets.

Therefore, it would be desirable to provide a method and system for providing career guidance information in an organized fashion using a computer program. It would further be desirable to provide a computer program for career guidance that accesses information on the Internet, providing up-to-date information via an Internet portal without requiring continual upgrade of the computer program in order to present up-to-date career information, while providing some information encoded in media such as compact disc read-only-memory (CD-ROM) or digital video disc (DVD).

### SUMMARY OF THE INVENTION

The above objective of providing organized and up-to-date career guidance information is achieved in a method and system. The method provides a career browser user interface from which a user selects a career from a drop-down list for one of multiple career categories. In response to selection of a career from a list, a screen is loaded containing career information such as a description of the job, educational requirements and salary ranges. A menu bar is provided for selection of other career sub-information including options for a “day-in-the-life” video, helper “bots” or conversational assistants that can interact with the user via voice or text interface, job statistics information and navigation controls. The information provided for the options (including video and audio information) as well as for the description area may be loaded from a storage media such as CD-ROM or loaded from servers on the Internet. Internet content is formatted for use within the display area of the career browser and the menu bar added, so that seamless integration of CD-ROM stored content and Internet loaded content is provided.

The foregoing and other objectives, features, and advantages of the invention will be apparent from the following, preferred embodiment of the accompanying drawings.

### BRIEF DESCRIPTION OF THE DRAWINGS

FIG. 1 is a block diagram depicting a networked computer system in which an embodiment of the invention may be practiced.

FIG. 2 is a pictorial diagram depicting a user interface of a program in accordance with an embodiment of the invention.

FIG. 3 is a pictorial diagram depicting another user interface of a program in accordance with an embodiment of the invention.

FIG. 4 is a flowchart depicting operation of a career guidance system in accordance with an embodiment of the invention.

### DETAILED DESCRIPTION OF THE PREFERRED EMBODIMENTS

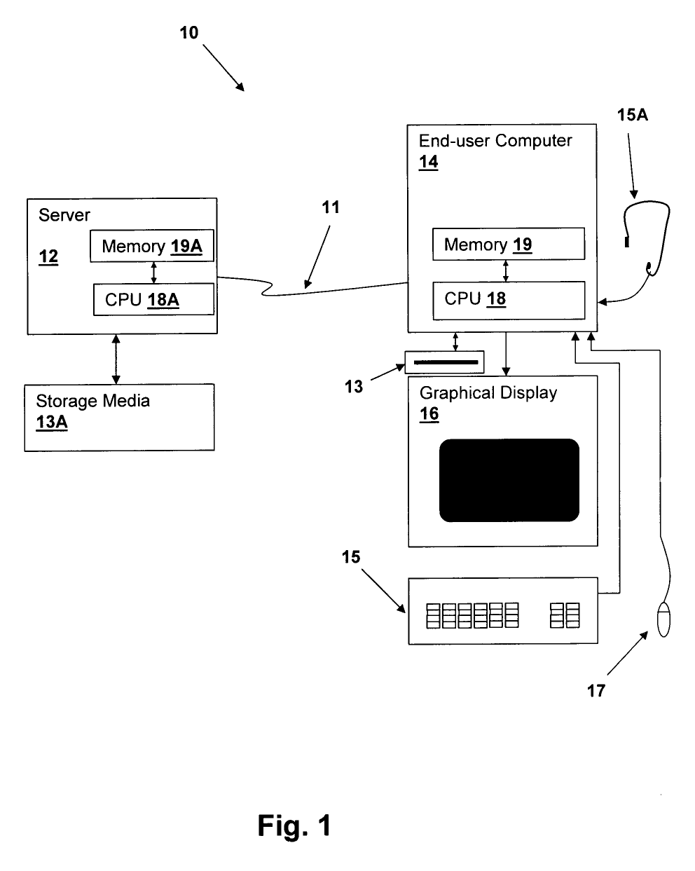

Referring now to FIG. 1, a system 10 in which embodiments of the present invention may be practiced is depicted in a block diagram. A server 12 is coupled to a signal-bearing media in the form of hard disk storage 13 having content available and optionally program instructions in the form of web page instructions for practicing portions of a method in accordance with an embodiment of the present invention that are loaded into a memory 19A and executed by one or more central processing units 18A (CPU). Server 12 is coupled to an end-user computer 14 via network connection 11, which may be an Ethernet connection coupled to routers, bridges or other terminal equipment for connection to a wide-area network, and thereby to the Internet. Alternatively, network connection may be a modem, DSL or cable modem connection coupled to end-user computer 14 for direct connection to the Internet as is typical in home installations. As such, network connection 11 represents a connection to the Internet or other suitable platform for connection to remote systems such as server 12. The present invention uses the network depicted in FIG. 1 to remotely deliver career information content in response to activity of a browser executed by a processor (CPU) 18 from a memory 19 within end-user computer 14. When a user having access to end-user computer 12 coupled to network connection 11 operates a program product of the present invention via the executing browser, the browser provides the user interface of the present invention which provides information on various careers in response to selection of a career from a job category.

End-user computer 12 is coupled to a graphical display 16 and input devices such as a keyboard 15 and mouse 17 providing interactivity with the browser program in order to provide access to the world-wide-web (WWW) and to the local program and career content of the present invention. End-user computer includes a storage media device 13 for loading the program of the present invention, generally a CD-ROM or DVD drive. Server 10 is accessed via the program of the present invention and may also be accessed directly by browser through the main browser window. Server 10 thus either provides career content in addition to that available from storage media inserted in storage media device 13, or may alternative provide the entire content via an Internet web page. A third alternative is that all content is local to end-user computer 14 and is loaded on-the-fly from storage media device 13 or copied to internal (hard drive) storage for access and execution via processor 18. A voice interface 15A is also provided in some embodiments of the present invention to enable interaction with “helpers” via voice. Voice interface 15A generally includes software and a sound interface within end-user computer 14 coupled to a headset as shown, but other voice interface configurations are well-known and are contemplated for use in providing voice input and output in accordance with embodiments of the present invention.

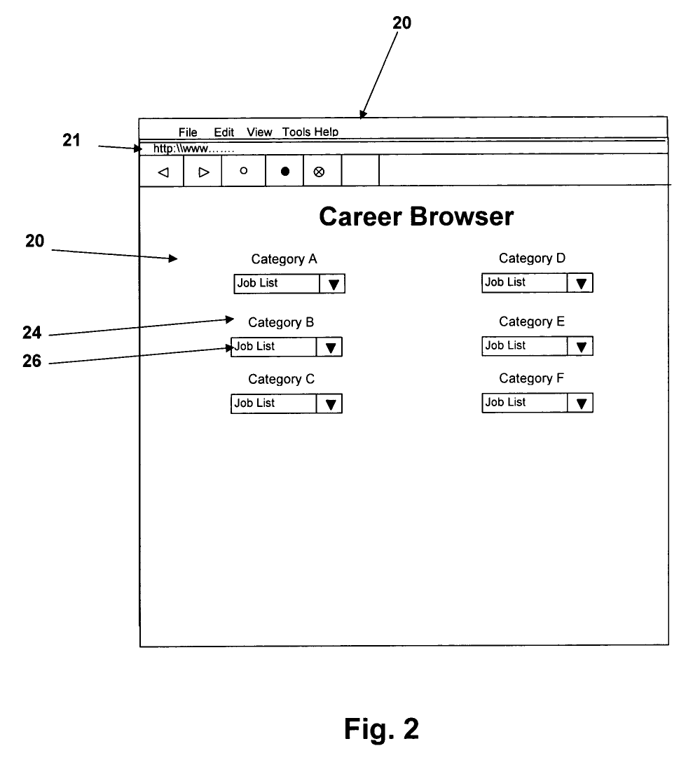

Referring now to FIG. 2, graphical output 20 of a browser program interacting with a user is depicted as an output as might be displayed on graphical display 16. Browser output 22 may be of a type generally in use, such as Navigator (manufactured by Netscape) or Internet Explorer (manufactured by Microsoft) or may alternatively be a dedicated program loaded into end-user computer 14 memory 19. A location bar 21 permits the user of the browser to direct the browser to interact with a web page. Browser output 22 depicts the graphical content of a web page, which may be a local file or a web page provided via an Internet world-wide-web (WWW) site. A set of job categories 24, such as entertainment, medicine, technology, manufacturing, etc. are displayed within browser output 22. A user selects the category by activating a drop-down list 26 associated with the job category and then selects a particular career from the drop down list. Upon selection, a page for the particular career is loaded into browser 20.

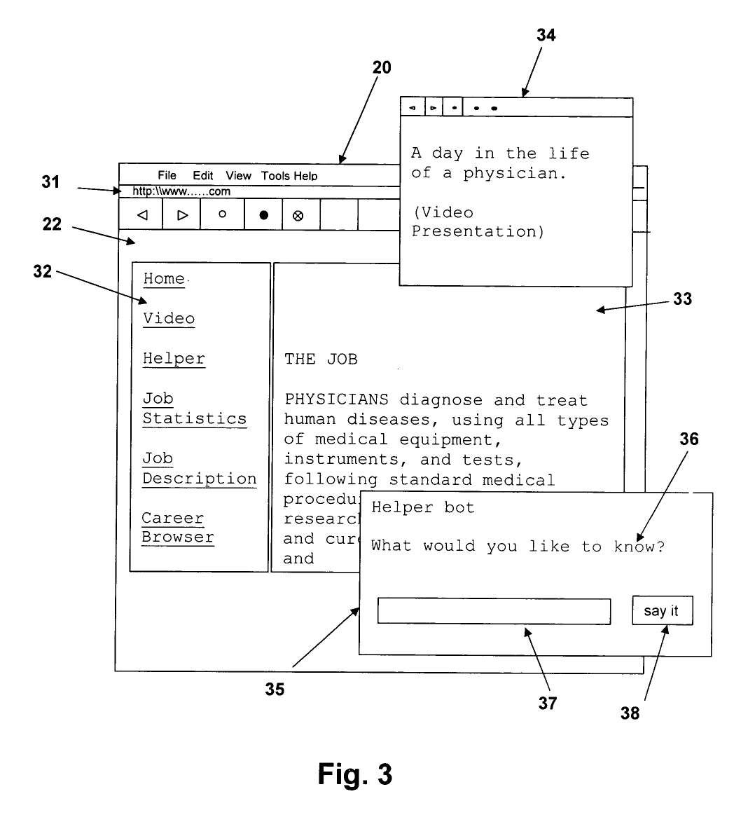

Referring now to FIG. 3 a second user interface in accordance with an embodiment of the present invention is depicted. After selection of a career as described above, browser 20 display area 22 (in response to loading of a local file, Internet page or combination of local and Internet-served information) displays a career description 33 and a further information options menu 32. The description contains summary information for a particular career and options menu 32 includes choices such as video, which activates playing of a day-in-the-life video, generally via a media player window 34, but may be provided within a window of browser display 22 or a video page may be loaded replacing menu 32 and career description 33. The day-in-the life video may include sound, text subtitles or both, and may be retrieved from local storage within end-user computer 14 or downloaded from server 12.

The day-in-the-life video described above is generally a depicting of what the day-to-day environment and tasks are for the particular selected career, rather than an talking interview format video. Options menu 32 also includes a helper option that loads a conversational helper such as chat helper bot depicted in chat window 35. The conversational helper interacts using text display 36 from the helper and the user can interact with the helper by entering text in entry area 37 and activating button 38 to transmit the entered text. Alternatively, a voice-interactive helper may be employed that interacts via voice interface 15A, requiring no on-screen display. However, either conversational helper may also include animations that provide further interaction with the user. Menu 32 options also include options for statistical information and further job description information which are displayed in area 33 in response to activation of menu 32 options.

In the exemplary browser output, all of the operational items associated with the example are depicted as being located within one web page including the pop-up windows depicted, but multiple pages may be used to separate the various steps associated with browsing career information. Internet-loaded content may be loaded from any server and formatted to include menu 32 so that a seamless integration of information provide, for example, from governmental sources provides up-to-date information that is presented within the graphical user interface of the present invention. Menu 32 may be provided in other areas of browser display area 22, including the top, bottom and right side of the display area 22 and the location and contents of menu 32, may be adjusted for presentation of Internet-loaded content.

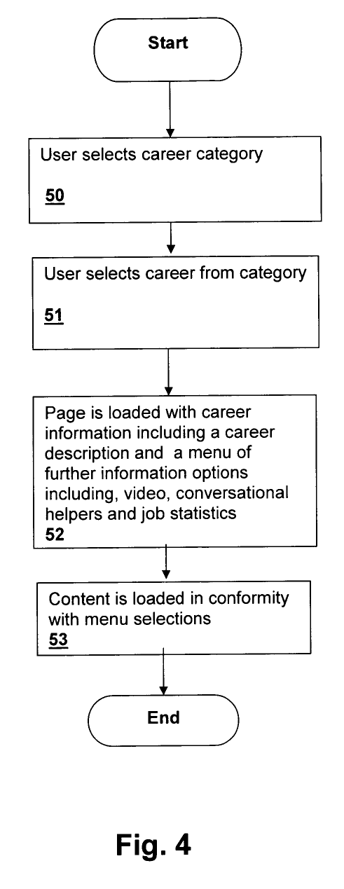

Referring now to FIG. 4, a method in accordance with an embodiment of the invention is depicted in a flowchart. First, a user selects (step 50) a career category by activating one of drop-down lists 26. Selection of the list item corresponding to a particular career (step 51) causes loading of a page (step 52) that includes a career description and a menu of further information items including video, conversational helpers and job statistics options. Finally, upon selection of menu items from the loaded page, content is loaded (from local files, the Internet or both) in conformity with the selected menu option (step 53).

While the invention has been particularly shown and described with reference to the preferred embodiments thereof, it will be understood by those skilled in the art that the foregoing and other changes in form, and details may be made therein without departing from the spirit and scope of the invention.

1. A method for providing career guidance information, comprising:
generating a user interface screen containing job categories from which a user may select a sub-menu containing careers within the job categories;
responsive to selection of one of said careers, generating a second user interface having a display area containing a description of said career and further providing a menu for selection of further information options for said career including a day-in-the-life video, career statistics and further career information; and
responsive to selection of one of said further information options, loading content for said option from one or more of a server on the Internet or a local storage, and wherein said second user interface is generate to provide said further information options in conjunction with said loaded content, whereby differences between Internet-loaded content and local storage-loaded content are minimized.

2. The method of claim 1, wherein said further information options include an option for selecting activation of a conversational helper for providing career information interactivity, and further comprising operating said conversational helper, whereby said conversational helper interacts with said user.

3. The method of claim 2, wherein said conversational helper interacts with said user within a text interface.

4. The method of claim 2, wherein said conversational helper interacts with said user via a voice interface.

5. The method of claim 1, further comprising in response to activation of said further information option associated with said day-in-the-life video, loading said information option via a video player system component.

6. The method of claim 1, wherein said first user interface and said second user interface are both provided within an Internet browser window.

7. The method of claim 1, wherein said first user interface, said second user interface and said content are all provided from said server.

8. The method of claim 1, wherein said first user interface, said second user interface and said content are all provided from local files.

9. A computer system comprising, a memory for storing program instructions and data; a processor for executing said program instructions; a media storage for storing career information and an Internet connection providing access to Internet content, and wherein said program instructions comprise program instructions for:
generating a user interface screen containing job categories from which a user may select a sub-menu containing careers within the job categories, responsive to selection of one of said careers, generating a second user interface having a display area containing a description of said career and further providing a menu for selection of further information options for said career including a day-in-the-life video, career statistics and further career information, and responsive to selection of one of said further information options, loading content for said option from one or more of a server on the Internet or a local storage, and wherein said second user interface is generate to provide said further information options in conjunction with said loaded content, whereby differences between Internet-loaded content and local storage-loaded content are minimized.

10. The computer system of claim 9, wherein said program instructions for generating said second interface provide further information options including an option for selecting activation of an conversational helper for providing career information interactivity, and further comprising program instructions for operating said conversational helper, whereby said conversational helper interacts with said user.

11. The computer system of claim 10, wherein program instructions for operating said conversational helper provide a text interface for interaction with said user.

12. The computer system of claim 10, wherein program instructions for operating said conversational helper provide a voice interface for interaction with said user.

13. The computer system of claim 9, further comprising program instructions for loading said information option via a video player system component, in response to activation of said further information option associated with said day-in-the-life video.

14. The computer system of claim 9, wherein said program instructions for generating said first user interface and said second user interface are both provided in an Internet browser, and wherein said first user interface and said second user interface are generated from content loaded into said Internet browser.

15. The computer system of claim 9, wherein program instructions for generating said first user interface, said second user interface and said content generate said first user interface, said second user interface and said content from information loaded from said server.

16. The computer system of claim 9, wherein program instructions for generating said first user interface, said second user interface and said content generate said first user interface, said second user interface and said content from information loaded from local files.

17. A computer program product comprising signal bearing media containing program instructions for execution with a general purpose computer system and data stored as local content files, said program instructions comprising program instructions for:
generating a user interface screen containing job categories from which a user may select a sub-menu containing careers within the job categories,
responsive to selection of one of said careers, generating a second user interface having a display area containing a description of said career and further providing a menu for selection of further information options for said career including a day-in-the-life video, career statistics and further career information, and
responsive to selection of one of said further information options, loading content for said option from one or more of a server on the Internet or said local content files, and wherein said second user interface is generate to provide said further information options in conjunction with said loaded content, whereby differences between Internet-loaded content and local content files are minimized.

18. The computer program product of claim 17, wherein said program instructions for generating said second interface provide further information options including an option for selecting activation of an conversational helper for providing career information interactivity, and further comprising program instructions for operating said conversational helper, whereby said conversational helper interacts with said user.

19. The computer program product system of claim 9, wherein said program instructions for generating said first user interface and said second user interface are both provided as web page instructions for an Internet browser, and wherein said first user interface and said second user interface are generated from said web page instructions.

20. The computer program product system of claim 9, wherein said program instructions for generating said first user interface and said second user interface are both provided as web page instructions for an Internet browser, and wherein said first user interface and said second user interface are generated from said web page instructions stored within said local content files.
